(19) United States
(12) Patent Application Publication
(10) Pub. No.: US 2015/0193790 A1
(43) Pub. Date: Jul. 9, 2015

(54) VIRTUAL PANEL CREATION METHOD AND APPARATUS

(71) Applicant: MASTERCARD INTERNATIONAL INCORPORATED, Purchase, NY (US)

(72) Inventors: Henry M. WEINBERGER, New York, NY (US); Bruce MacNAIR, Stamford, CT (US)

(73) Assignee: MASTERCARD INTERNATIONAL INCORPORATED, Purchase, NY (US)

(21) Appl. No.: 14/148,199

(22) Filed: Jan. 6, 2014

(51) Int. Cl. G06Q 30/02

(52) U.S. Cl. CPC G06Q 30/0202

(57) ABSTRACT

A system, method, and computer readable storage medium configured to use a selected set of financial accounts to create a virtual panel which measures behavior from a sample of consumers that is representative of the overall consumer population across key geographic, demographic, and behavior dimensions in an in-memory modeling environment.

### BACKGROUND

1. Field of the Disclosure

Aspects of the disclosure relate in general to the processing, analysis, and modeling of large amounts of data. Aspects include an apparatus, system, method and computer readable storage medium to use a selected set of financial accounts to create a virtual panel which measures behavior from a sample of consumers that is representative of the overall consumer population across key geographic, demographic, and behavior dimensions in an in-memory modeling environment.

2. Description of the Related Art

A panel is a data collection mechanism used to collect quantitative or qualitative information about the participants' personal and economic habits set against their particular demographic. Typically, incentivized (“paid”) surveys are considered to be more likely to catch a wider and more representative range of respondents compared to unpaid surveys. The incentive is used to ensure that samples are as representative as possible, and that responses are not tilted towards those passionately interested in the subject of the particular survey.

To construct a panel, market research companies recruit participants and gather information. Typically, thousands of respondents are contacted over weeks and months to conduct interviews through telephone, mail or the Internet.

Large corporations from around the world pay millions of dollars to research companies to collect data on public opinions, product reviews and consumer behavior by using these surveys. The completed surveys directly influence the development of products and services from these companies.

When a research company needs respondents from a demographic they cannot reach, they can reach out to a nationwide or specialty panel. By offering a cash incentive to respondents in return for feedback these companies are able to fill quotas and collect information that reflects the attitudes or behavior in the overall universe of consumers being sought by the client.

As panels result from surveys of people, the honesty and correctness of survey responses directly affect the accuracy of a panel. It is also very important that the overall composition of the panel reflects the demographic and geographic characteristics of the broader consumer population in order for the data collected from the panel to reflect the overall marketplace.

### SUMMARY

Embodiments include a system, device, method and computer readable medium configured to model a virtual panel.

An apparatus embodiment includes a non-transitory computer readable storage medium and a processor. The processor retrieves records of financial transactions from a specified time period from the non-transitory computer readable storage medium. Each record contains an account identification code, an amount of a transaction, and an industry segment. The processor filters records using a behavior filter, and assigns each account a home geographic code. Percentage quotas are established for geographic and/or demographic cells using geographic and demographic data distributions. A number of accounts are selected within each geo-demographic cell to match the overall geo-demographic data distributions of the general consumer population. The processor scales the number of accounts within each geographic cell to match the geographic data distributions to result in a virtual panel. The resulting virtual panel is saved to a non-transitory computer-readable storage medium.

### BRIEF DESCRIPTION OF THE DRAWINGS

FIG. 1 depicts a block diagram of a modeling device configured to model a virtual panel.

FIG. 2 flowcharts a method embodiment to construct behavioral filters for a virtual panel model.

FIG. 3 illustrates a flowchart of a method embodiment to construct a virtual panel.

### DETAILED DESCRIPTION

One aspect of the disclosure includes the realization that a virtual panel of consumer behavior may be constructed from the billions of financial transactions that occur in a payment network. An example payment network includes MasterCard International Incorporated of Purchase, N.Y. Financial transactions may include credit, debit, charge, prepaid payment card, checking, savings, balance-transfer transactions, and the like.

Another realization is that virtual panels may be used to create stable merchant benchmarking products.

Another aspect of the disclosure includes the understanding that not all payment network financial transactions are applicable for use in a virtual panel. First, not all financial accounts are equally representative of overall consumer behavior. Second, transaction data for a virtual panel is drawn from a stratified, quota-driven sample of financial accounts that would match the applicable population across a number of possible key geographic, demographic and behavioral dimensions. In one embodiment, such a panel is more representative of the United States consumer population than the raw sample of payment card account holders, and would continue to be representative in the face of market, consumer preference and payment network share changes.

In yet another aspect, the virtual panel creation and maintenance of customer inflow/outflow would be much more efficient than conventional panels, since panel members would not need to be recruited, but would become eligible simply by their characteristics from the payment network's transaction database. As a consequence, there could be hundreds of thousands—if not millions of panel members. Additionally, such a virtual panel has the added benefit of measuring panel members' actual purchase behavior, not just what the panel members report.

In another aspect, as panel members are not recruited, no payments to panelists are involved.

Embodiments of the present disclosure include a system, method, and computer readable storage medium configured to model a virtual panel in an in-memory modeling environment.

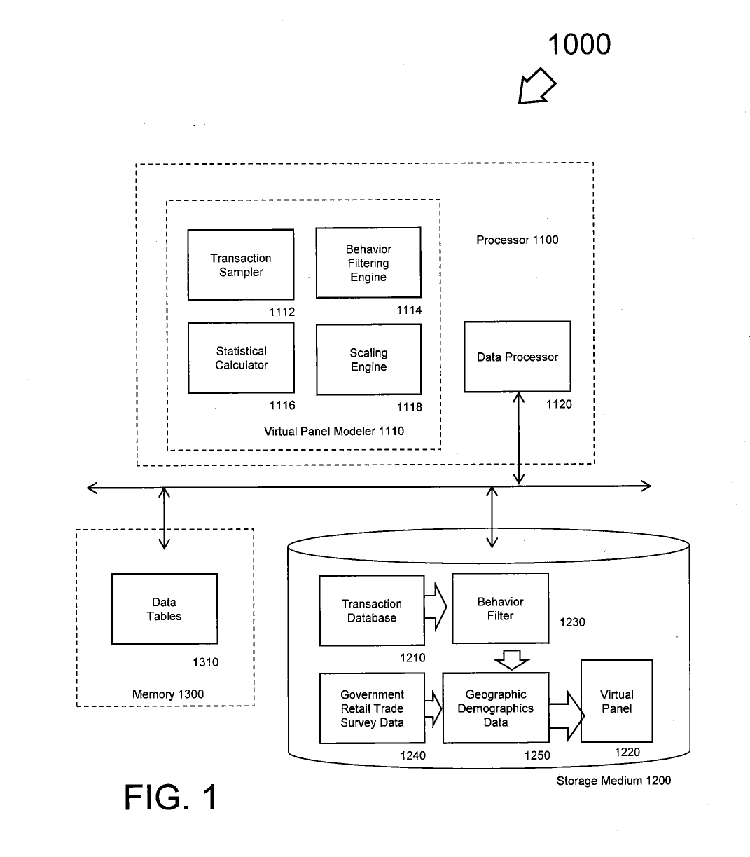

FIG. 1 illustrates an embodiment of a modeling device 1000 configured to model a virtual panel in an in-memory modeling environment, constructed and operative in accordance with an embodiment of the present disclosure.

Modeling device 1000 may run a multi-tasking operating system (OS) and include at least one processor or central processing unit (CPU) 1100, a non-transitory computer readable storage medium 1200, and computer memory 1300. An example operating system may include Advanced Interactive Executive (AIX™) operating system, UNIX operating system, or LINUX operating system, and the like.

Processor 1100 may be any central processing unit, microprocessor, micro-controller, computational device or circuit known in the art.

As shown in FIG. 1, processor 1100 is functionally comprised of a virtual panel modeler 1110 and a data processor 1120.

Virtual panel modeler 1110 is a modeling environment configured to execute a virtual model. In this embodiment, the virtual model is a virtual panel. Furthermore, virtual panel modeler 1110 may comprise: transaction sampler 1112, behavior filtering engine 1114, statistical calculator 1116, and scaling engine 1118.

Transaction sampler 1112 is the element of processor 1100 to sample, slice, variable screen, and otherwise process a dataset of transaction data into manageable size.

Behavior filtering engine 1114 enables processor 1100 to construct and execute filters for transaction data.

Statistical calculator 1116 is the portion of the processor 1100 that performs statistical analysis. For example, statistical calculator 1116 may be able to determine the total variation distance between two probability measures. In some embodiments, statistical calculator is configured to perform a Kolmogorov-Smirnov test (K-S test), Shapiro-Wilk test, Anderson-Darling test, or the like.

Scaling engine 1118 is the portion of processor 1100 to scale modeling information into a virtual panel.

Data processor 1120 enables processor 1100 to interface with memory 1300, storage media 1200, or any other component not on the processor 1100. The data processor 1120 enables processor 1100 to locate data on, read data from, and write data to these components.

These structures may be implemented as hardware, firmware, or software encoded on a computer readable medium, such as storage media 1200. Further details of these components are described with their relation to method embodiments below.

Memory 1300 may be any computer memory known in the art for volatile or non-volatile storage of data or program instructions. An example memory 1300 may be Random Access Memory (RAM). As shown, memory 1300 may store data tables 1310, for instance.

Computer readable storage media 1200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer readable memory device as is known in the art for storing and retrieving data. Significantly, computer readable storage media 1200 may be remotely located from processor 1100, and be connected to processor 1100 via a network such as a local area network (LAN), a wide area network (WAN), or the Internet.

In addition, as shown in FIG. 1, storage media 1200 may also contain a transaction database 1210, behavior filter 1230, government or commercially-available data on retail spending 1240, geo-demographic data 1250, and a virtual panel 1220. Transaction database 1210 is a database of payment card transactions at a payment network; the transaction database 1210 may contain all payment cardholder accounts that have financial transactions within a determined time period. Virtual panel 1220 is configured to store the model or result of the virtual panel modeler 1110. Behavior filter 1230 is a financial transaction filter generated and executed by behavior filtering engine 1114. Government or commercially-available retail spending data 1240 is data provided by a government or commercial entity, used to measure the overall size of and trends within the consumer spending universe, in total and by various types of goods or services. Using Merchant Category Codes with card transactions, the virtual panel modeler 1110 can determine the type of industry a financial transaction is taking place at. Geo-demographic data 1250 is private entity or census distribution information on the overall consumer universe. Geo-demographic data 1250 enables virtual panel modeler 1110 to more accurately represent a specific geographical area. For example, if 1% of U.S. consumers live in Cook County, Ill., then 1% of a nation-wide virtual panel 1220 is derived from Cook County.

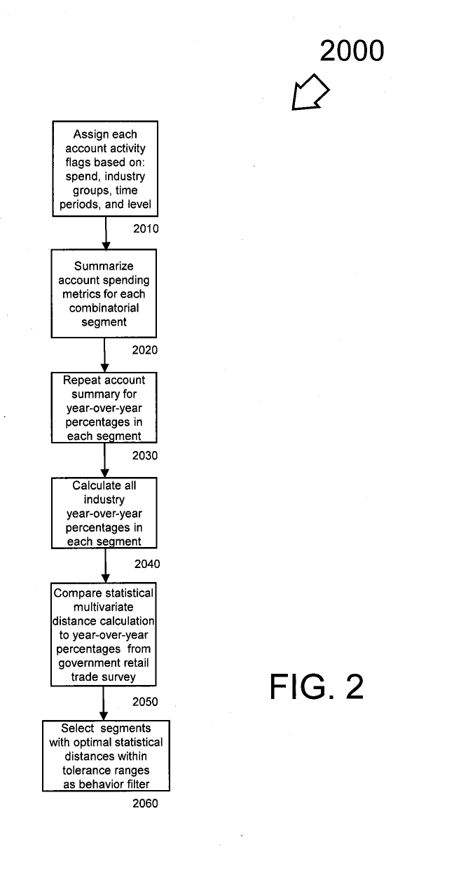

It is understood by those familiar with the art that one or more of these databases 1210-1250 may be combined in a myriad of combinations. These structures 1210-1250 may be any relational database known in the art, such as SQL, SQLite, MySQL, PosgreSQL, or the like. The function of these structures may best be understood with respect to the flowcharts of FIG. 2, as described below.

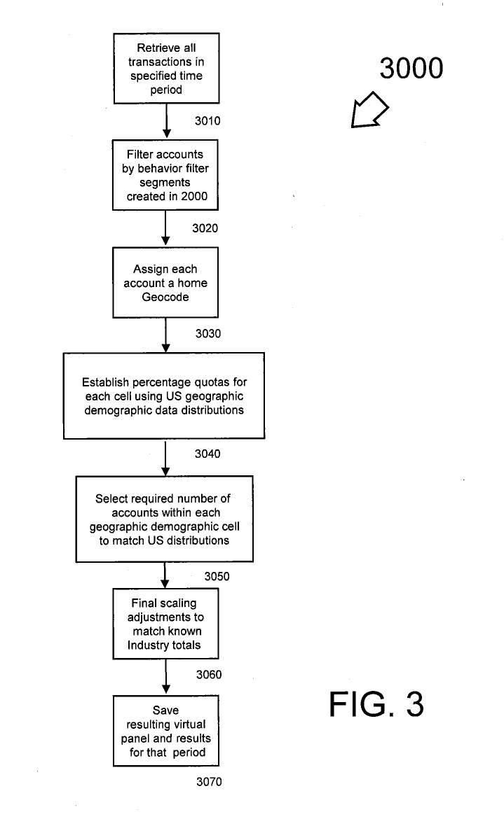

We now turn our attention to method or process embodiments of the present disclosure, FIG. 2 and FIG. 3. It is understood by those known in the art that instructions for such method embodiments may be stored on their respective computer readable memory and executed by their respective processors. It is understood by those skilled in the art that other equivalent implementations can exist without departing from the spirit or claims of the disclosure.

FIG. 2 flowchart a modeling method 2000 embodiment to construct behavior filters 1230 for a virtual panel 1220 in an in-memory modeling environment, constructed and operative in accordance with an embodiment of the present disclosure. In this embodiment, the behavior filters 1230 are designed to identify a set of financial accounts whose transactional patterns are most reflective of the time series spend patterns seen in Government or Commercial Retail Spend Data 1240. This process results in a set of rules that are used to filter financial transactions that represent economic activity in a certain time period for a virtual panel 1220 representing that time period. It is understood that various time intervals may be used for selecting financial accounts that will be used as members of a virtual panel 1220, and that the resulting behavior filter 1230 would be adjusted accordingly.

At block 2010, all the payment cardholder accounts in a transaction database 1210 are assigned activity flags, based on spend, penetration of different industry groups, time periods, and level.

The account spending is summarized for each of a plurality of combinatorial segments, block 2020. Those combinatorial segments contain groups of financial accounts who show similar spend behavior with regard to the combination of merchant categories in which they have spent as well as the overall spend frequency displayed by each account. An example of a combinatorial segment would be accounts that have had financial expenditures in at least three different merchant categories in a set time period, made at least two grocery transactions over the last three months, and were active for at least a year. Government retail trade survey data or other commercially-available data 1240 may be used to determine the overall number of transactions or spending that has occurred in the past year in a given merchant category. The account summary by combinatorial segment is repeated for the “year ago” time period preceding the current year, block 2030, and a “year-over-year” comparison of consumer financial activity is done for a number of merchant categories.

Year-over-year percentage comparisons are calculated for each merchant category segment, block 2040. At block 2050, the accuracy of the comparison can be made by comparing the calculation from the statistical calculator 1116 with a merchant category-weighted statistical multivariable distance calculation to year-over-year industry performance reported from a government retail trade survey data or other commercially-available data 1240.

Segments with statistical distances within acceptable tolerance ranges are selected and saved by the behavior filtering engine 1114 as behavior filters 1230, block 2060, and the process ends. The acceptable tolerance range will be based on a comparison of the average Year-over-Year growth percentage by merchant category against the related growth number from the government retail trade survey data or other commercially-available data 1240. In some embodiments, the acceptable tolerance range is two standard deviations.

FIG. 3 illustrates a flowchart of a method 3000 to construct a virtual panel 1220, constructed and operative in accordance with an embodiment of the present disclosure. It is understood by those familiar with the art that such a virtual panel construction method 3000 may be used in conjunction or separately from the behavior filtering construction method 2000.

For illustrative purposes only, the virtual panel 1220 represents a year of economic activity. It is understood that other time intervals (months, quarters, years, decades, or any combination thereof) may be used for a virtual panel 1220, and that the resulting behavior filter 1230 would be adjusted accordingly.

Virtual panel 1220 may cover any geographical region. Furthermore, for illustrative purposes, the embodiment herein discusses a virtual panel 1220 for the entire United States.

At block 3010, transaction sampler 1112 retrieves all the financial transaction accounts from transaction database 1210 in a specified time period. As mentioned above, for the sake of example, this time period is assumed to be one year. The financial transaction accounts retrieved are accounts that have credit or debit transactions in the specified time period. As an order of magnitude, this may be tens or even hundreds of millions of such accounts in the United States. The number of accounts is reduced by behavior filter 1230, block 3020. In some embodiments, the behavior filter 1230 may have been generated by process 2000.

Each financial transaction account is assigned a home geographic code, based on the location of the account holder, block 3030. For example, the home geographic code may be assigned via postal code (e.g., “ZIP code”).

Using geo-demographic data 1250, the number of consumers is estimated for each geo-demographic code, and the percentage that the geo-demographic code represents of the overall virtual panel—in this particular example, the United States as a whole, block 3040. Geo-demographic data 1250 is population distribution information, which may include public census data or commercially-available population data derived from research companies. As mentioned previously, geo-demographic data 1250 enables virtual panel modeler 1110 to more accurately represent a specific geographic or demographic segment of the population.

At block 3050, virtual panel modeler 1110 selects a number of accounts within each geo-demographic code to match the United States population distributions.

Once matched, the results are scaling adjusted to extrapolate to the United States population distributions, block 3060. For example, if the virtual panel has 20 million accounts, and there are 200 million consumers, the final extrapolation would be a 10-to-1 ratio. The process may then summarize and compute all desired merchant, industry, and geographic metric for the current period.

The resulting virtual panel 1220 and results for the period are then saved, block 3070.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A virtual panel modeling method comprising:
retrieving records of financial transactions from a specified time period, each record containing an account identification code, an amount of a transaction, and an industry segment;
filtering records with a processor using a behavior filter;
assigning each account a home geographic code with the processor;
establishing, with the processor, percentage quotas for geo-demographic cells using geo-demographic data distributions;
selecting, with the processor, a number of accounts within each geo-demographic cell to match the geo-demographic data distributions;
scaling, with the processor, the number of accounts within each geo-demographic cell in the virtual panel to match the geo-demographic data distributions of the overall consumer universe; and
saving the resulting virtual panel to a non-transitory computer-readable storage medium.

2. The method of claim 1, wherein the behavioral filter is configured to flag financial transaction activity based on spending, industry segment, time periods, or level.

3. The method of claim 2, wherein the behavioral filter is further configured to summarize account spending metrics for a combinatorial segment.

4. The method of claim 3, wherein the behavioral filter is further configured to summarize account spending metrics for year-over-year percentages in the combinatorial segment.

5. The method of claim 4, wherein the behavioral filter is further configured to compare statistical multivariate distances between the summarized account spending metrics with year-over-year percentages from a government retail trade survey.

6. The method of claim 5, wherein the behavioral filter is further configured to select the combinatorial segments within a predetermined tolerance range when compared to the year-over-year percentages from the government retail trade survey.

7. A payment network apparatus comprising:
a non-transitory computer readable storage medium configured to store records of financial transactions from a specified time period, each record containing an account, an amount of a transaction, and an industry segment;
a processor configured to filter records using a behavior filter, assign each account a home geographic code, establish percentage quotas for geo-demographic cells using geo-demographic data distributions, select a number of accounts within each geo-demographic cell to match the geo-demographic data distributions, scale the number of accounts within each geo-demographic cell to match the geo-demographic data distributions of the overall consumer universe; and
wherein the non-transitory computer readable storage medium is further configured to the save a resulting virtual panel to a non-transitory computer-readable storage medium.

8. The apparatus of claim 7, wherein the behavioral filter is configured to flag financial transaction activity based on spending, industry segment, time periods, or level.

9. The apparatus of claim 8, wherein the behavioral filter is further configured to summarize account spending metrics for a combinatorial segment.

10. The apparatus of claim 9, wherein the behavioral filter is further configured to summarize account spending metrics for year-over-year percentages in the combinatorial segment.

11. The apparatus of claim 10, wherein the behavioral filter is further configured to compare statistical multivariate distances between the summarized account spending metrics with year-over-year percentages from a government retail trade survey.

12. The apparatus of claim 11, wherein the behavioral filter is further configured to select the combinatorial segments within a predetermined tolerance range when compared to the year-over-year percentages from the government retail trade survey.

13. A non-transitory computer readable medium encoded with data and instructions, when executed by a computing device the instructions causing the computing device to:
retrieve records of financial transactions from a specified time period, each record containing an account identification code, an amount of a transaction, and a merchant category;
filter records with a processor using a behavior filter;
assign each account a home geographic code with the processor;
establish, with the processor, percentage quotas for geo-demographic cells using geo-demographic data distributions;
select, with the processor, a number of accounts within each geo-demographic cell to match the geo-demographic distributions of the overall consumer universe;
scale, with the processor, the number of accounts within each geo-demographic cell to match the geo-demographic data distributions of the overall consumer universe; and
save the resulting virtual panel to the non-transitory computer-readable storage medium.

14. The non-transitory computer readable medium of claim 13, wherein the behavioral filter is configured to flag financial transaction activity based on spending, industry segment, time periods, or level.

15. The non-transitory computer readable medium of claim 14, wherein the behavioral filter is further configured to summarize account spending metrics for a combinatorial segment.

16. The non-transitory computer readable medium of claim 15, wherein the behavioral filter is further configured to summarize account spending metrics for year-over-year percentages in the combinatorial segment.

17. The non-transitory computer readable medium of claim 16, wherein the behavioral filter is further configured to compare statistical multivariate distances between the summarized account spending metrics with year-over-year percentages from a government retail trade survey.

18. The non-transitory computer readable medium of claim 17, wherein the behavioral filter is further configured to select the combinatorial segments within a predetermined tolerance range when compared to the year-over-year percentages from the government retail trade survey.
